(19) United States
(12) Patent Application Publication
(10) Pub. No.: US 2019/0196461 A1
(43) Pub. Date: Jun. 27, 2019

(54) INTERNET-BASED SEMICONDUCTOR MANUFACTURING EQUIPMENT HEALTH AND DIAGNOSTICS MONITORING

(71) Applicant: APPLIED MATERIALS, INC., Santa Clara, CA (US)

(72) Inventors: DINESH SAIGAL, San Jose, CA (US); SARIL RAGHU, San Francisco, CA (US); ALFRED LINKE, Santa Clara, CA (US); AN BAO TRAN, San Jose, CA (US); GIL ONTIVEROS, San Jose, CA (US); JOHN C. FORSTER, Sunnyvale, CA (US); WARREN WOODS, Santa Clara, CA (US)

(21) Appl. No.: 16/227,795

(22) Filed: Dec. 20, 2018

Related U.S. Application Data
(60) Provisional application No. 62/609,861, filed on Dec. 22, 2017.

(51) Int. Cl. G05B 23/02; G05B 19/418; G06F 11/07

(52) U.S. Cl. CPC G05B 23/0283; G05B 23/0216; G05B 2223/06; G05B 19/4184; G06F 11/0793; G05B 23/0275

(57) ABSTRACT

A system, apparatus and method for internet-based health and diagnostic monitoring of semiconductor manufacturing components include receiving health and diagnostic information and data from at least one component of a semiconductor manufacturing system, evaluating the received health and diagnostic information and data to determine if at least one of the at least one component of the semiconductor manufacturing system for which the health and diagnostic information and data was received is faulty, and if determined that at least one of the at least one component of the semiconductor manufacturing system is faulty, initiating a corrective action for the faulty component over the internet.

### CROSS-REFERENCE TO RELATED APPLICATIONS

This application claims benefit of U.S. provisional application Ser. No. 62/609,861, filed Dec. 22, 2017, which is herein incorporated by reference in its entirety.

### FIELD

Embodiments of the present disclosure generally relate to systems, apparatuses and methods for performing semiconductor manufacturing equipment health and diagnostics monitoring and, particularly, to systems, apparatuses and methods for applying the internet of things (IoT) to semiconductor manufacturing equipment health and diagnostic monitoring to initiate service and parts replacement.

### BACKGROUND

These days, components of semiconductor manufacturing equipment typically include a controller or internal circuits for performing health monitoring and component diagnostics. Information and data collected regarding the health and diagnostics of components are typically stored in a local memory or storage associated with the respective components.

Currently, a diagnostic engineer is required to visit a site in which the components are located and to use an interface device to review/download the stored information and data collected regarding the health and diagnostics of the local components of the semiconductor manufacturing equipment. The diagnostic engineer can then make decisions regarding whether a component needs to be serviced, repaired or replaced.

The time and cost required to deploy a diagnostic engineer to a site to collect and diagnose information and data collected regarding the health and diagnostics of local components can be prohibitive, especially considering that components of a semiconductor manufacturing equipment system can require a respective diagnostic engineer to be deployed for components from different manufacturers. In addition, a delay in ordering replacement parts associated with having to deploy a diagnostic engineer to a local site can result in a substantial amount of down time for a semiconductor manufacturing equipment system, which can result in substantial revenue loss.

### SUMMARY

Embodiments of the present principles for internet-based semiconductor manufacturing equipment diagnostics and health monitoring advantageously facilitate the communication with semiconductor manufacturing equipment components and the transmittal of health and diagnostic information and data collected for the components to facilitate the servicing, repair or replacement of semiconductor manufacturing equipment components over the internet.

In some embodiments in accordance with the present principles, a method for internet-based health and diagnostic monitoring of semiconductor manufacturing components includes receiving health and diagnostic information and data from at least one component of a semiconductor manufacturing system, evaluating the received health and diagnostic information and data to determine if at least one of the at least one component of the semiconductor manufacturing system for which the health and diagnostic information and data was received is faulty, and if determined that at least one of the at least one component of the semiconductor manufacturing system is faulty, initiating a corrective action for the faulty component over the internet.

In some embodiments in accordance with the present principles, an apparatus for internet-based health and diagnostic monitoring of semiconductor manufacturing components includes a memory to store at least program instructions and data and a processor to execute the program instructions to configure the apparatus to receive health and diagnostic information and data from at least one component of a semiconductor manufacturing system, evaluate the received health and diagnostic information and data to determine if at least one of the at least one component of the semiconductor manufacturing system for which the health and diagnostic information and data was received is faulty, and if determined that at least one of the at least one component of the semiconductor manufacturing system is faulty, initiate a corrective action for the faulty component over the internet.

In some embodiments in accordance with the present principles, a system for internet-based health and diagnostic monitoring of semiconductor manufacturing components includes a process chamber to process substrates, the process chamber comprising at least one component and an apparatus comprising a memory to store at least program instructions and data and a processor, when executing the program instructions, to configure the apparatus to receive health and diagnostic information and data from the at least one component of the process chamber, evaluate the received health and diagnostic information and data to determine if at least one of the at least one component of process chamber for which the health and diagnostic information and data was received is faulty and if determined that at least one of the at least one component of the process chamber is faulty, initiate a corrective action for the faulty component over the internet.

In some embodiments in accordance with the present principles, a method for internet-based health and diagnostic monitoring of semiconductor manufacturing components includes receiving health and diagnostic information and data from at least one component of a semiconductor manufacturing system and communicating the received health and diagnostic information and data over the internet to a remote site at which a determination is made if at least one of the at least one component of the semiconductor manufacturing system for which the health and diagnostic information and data was received is faulty. If determined that at least one of the at least one component of the semiconductor manufacturing system is faulty, a corrective action is initiated for the faulty component over the internet.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 depicts a high level block diagram of a semiconductor manufacturing system in accordance with an embodiment of the present principles.

FIG. 2 depicts a high level block diagram of a processing chamber and processing chamber components suitable for use in the system of FIG. 1 in accordance with an embodiment of the present principles.

FIG. 3 depicts a flow diagram of a method for internet-based health and diagnostic monitoring of semiconductor manufacturing components to initiate service and parts replacement in accordance with an embodiment of the present principles.

FIG. 4 depicts a high level block diagram of an internet of things (IoT) controller in accordance with an embodiment of the present principles.

FIG. 5 depicts a table of exemplary components and operating parameters of the components that can be monitored in accordance with embodiments of the present principles.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

Systems, apparatuses and methods for internet-based semiconductor manufacturing equipment diagnostics and health monitoring are provided herein. The inventive systems, apparatuses and methods advantageously facilitate the communication with semiconductor manufacturing equipment components and the transmission of health and diagnostic information and data collected for the components to facilitate the servicing, repair or replacement of semiconductor manufacturing equipment components over the internet. In some embodiments in accordance with the present principles, health and diagnostic information and data can include current values of operating parameters of components of, for example, a semiconductor manufacturing system. Such operating parameter values can be compared with optimal operating parameter values or thresholds to determine if a component requires service, parts or replacement.

Although embodiments of the present principles will be described with respect to specific systems and circuits having specific configurations for collecting and evaluating diagnostic information and data collected for components of a semiconductor manufacturing system, modifications can be made to the depicted systems and circuits and included components without departing from the scope of the present principles.

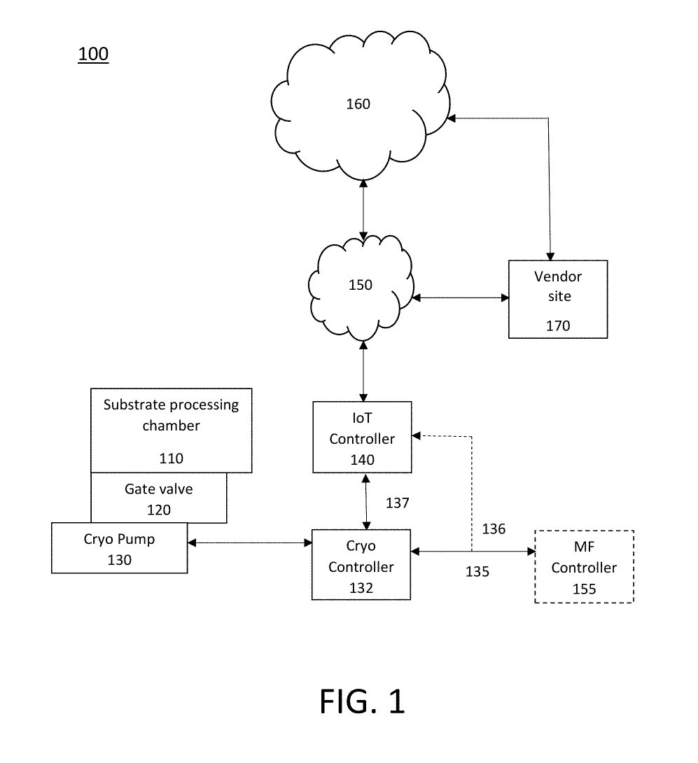

FIG. 1 depicts a high level block diagram of a semiconductor manufacturing system 100 in accordance with an embodiment of the present principles. The semiconductor manufacturing system 100 of FIG. 1 illustratively comprises a substrate processing chamber 110, a gate valve 120, a processing chamber component, illustratively a cryo pump 130, a cryo pump controller 132, an internet of things (IoT) controller 140 and an optional MF controller 155, which will be described in greater detail below. Illustratively depicted in FIG. 1 are also an internet 150, a cloud computing environment 160 and a vendor site 170. Although in the embodiment of FIG. 1, the IoT controller 140 is depicted as a stand-alone component, in alternate embodiments in accordance with the present principles, the IoT controller 140 can be integrated into another component of the semiconductor manufacturing system 100, such as the cryo pump 130, the cryo pump controller 132 and the optional MF controller 155.

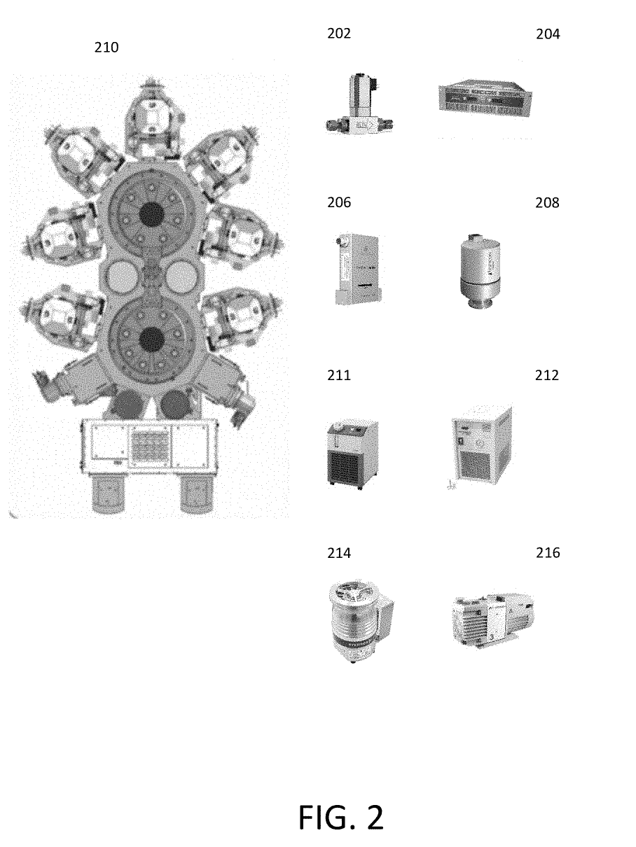

Although in the embodiment of FIG. 1, the processing chamber component is illustratively a cryo pump 130, in alternate embodiments in accordance with the present principles, for example and as depicted in FIG. 2, the processing chamber component can comprise a valve 202, a power supply 204, a mass flow control (MFC) 206, a gauge 208, a chiller 211, a DI cooler 212, a turbo pump 214, a mechanical pump 216 or any other component of a substrate processing chamber 210 capable of capturing information and data related to health monitoring and component diagnostics.

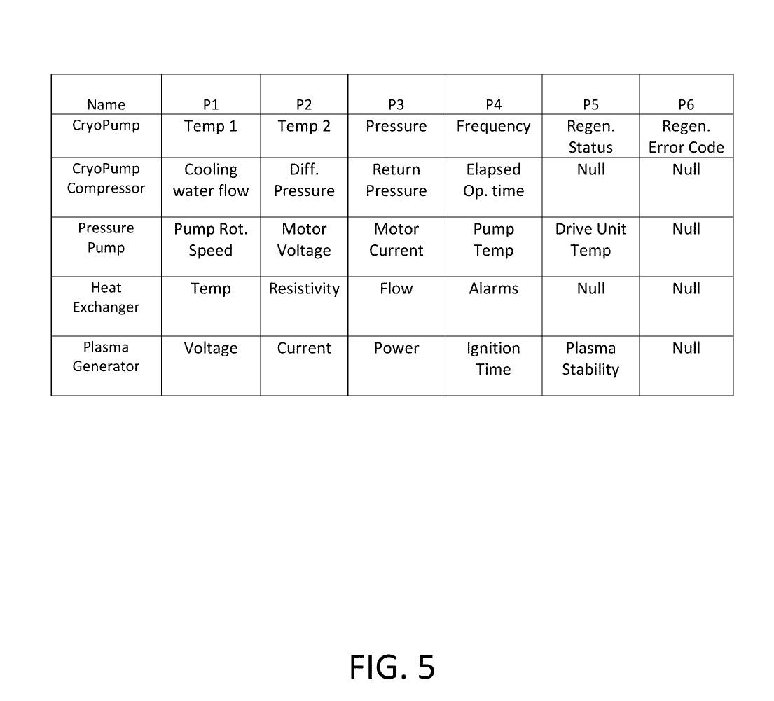

FIG. 5 depicts a table of exemplary components and operating parameters of the components that can be monitored to determine, for example, a health status of the components in accordance with embodiments of the present principles. As depicted in FIG. 5, operating parameters of a cryopump such as temperature, pressure, frequency, regeneration status and regeneration error codes can be monitored to determine a health status of the cryopump. In the embodiment of FIG. 5, operating parameters of a cryopump compressor such as cooling water flow, differential pressure, return pressure, and elapsed operating time can also be monitored. FIG. 5 depicts more examples of components that can be monitored, such as a pressure pump, a heat exchanger and a plasma generator and parameters that can be monitored such as pump speeds, motor voltages and currents, pump temperatures, resistivity, flows, power, ignition times, plasma stability measures and the like.

In the semiconductor manufacturing system 100 of FIG. 1, the cryo pump controller 132 receives health and diagnostic data and information from the cryo pump 130, which, in some embodiments, includes circuits for capturing performance characteristics and operating values of the cryo pump 130. The cryo pump controller 132 communicates the health and diagnostic information and data to the IoT controller 140. In accordance with embodiments of the present principles, the cryo pump controller 132 only communicates health and diagnostic information and data to the IoT controller 140 and refrains from communicating proprietary data or information, for example wafer production recipes, to the IoT controller 140.

In one embodiment in accordance with the present principles the cryo pump controller 132 can communicate with the IoT controller 140 via a physical cable 135, such as an RS-232 cable, that in some embodiments can be used to communicate information from the cryo pump controller 132 to the optional MF controller 155. The MF controller 155 in the optional embodiment of FIG. 1 is implemented as the main computing module that controls the components of the semiconductor manufacturing system 100, including hardware, software, and wafer production recipes and formulas. In such embodiments, the RS-232 cable connecting the cryo pump controller 132 to the optional MF controller 155 can be tied 136 into to provide the health and diagnostic information and data of the cryo pump 130 to the IoT controller 140. In such embodiments, only the portions of the RS-232 cable carrying health and diagnostic information and data are tied into to connect the cryo pump controller 132 to the IoT controller 140, such that only health and diagnostic information and data and not any proprietary data or information is communicated to the IoT controller 140. In some embodiments in accordance with the present principles, the cryo pump controller 132 can communicate with the IoT controller 140 via a dedicated physical cable 137.

Alternatively or in addition, the cryo pump controller 132 can communicate wirelessly with the IoT controller 140. Such wireless communications can include near field communication, Bluetooth communication, IEEE488 communication, Modbus, DNET, Cellular, LPWAN, EtherCAT, Zigbee or any other forms of wireless communication.

In some embodiments in accordance with the present principles, the IoT controller 140 communicates the health and diagnostic information and data received from the cryo pump controller 132 over an internet 150 to a vendor site 170. At the vendor site 170, a technician can monitor the health and diagnostic information and data communicated from the IoT controller 140 using, for example, a user interface and appropriate software. For example, the health and diagnostic information and data communicated from the IoT controller 140 can be displayed to a technician at the vendor site 170. The technician at the vendor site 170 can monitor and evaluate the health and diagnostic information and data received from the IoT controller 140 and determine if the cryo pump 130 is faulty. If determined that a component (e.g., the cryo pump 130) is faulty, the technician at the vendor site 170 can at least one of, schedule a service for the cryo pump 130, order a replacement part for the cryo pump 130 and order a replacement cryo pump 130.

Alternatively or in addition, the IoT controller 140 can upload the health and diagnostic information and data from the cryo pump controller 132 to a cloud computing environment 160 to take advantage of the on-demand computing resources. In such embodiments, a vendor or technician for a vendor can access the information on the cloud computing environment 160 uploaded by the IoT controller 140 using, for example, a user interface and software, for example in one embodiment, Microsoft Azure IoT portal, to monitor the performance of the cryo pump 130 to determine if the cryo pump 130 is faulty. Azure is a cloud base service provided by Microsoft used for deploying, and managing applications used for data collection, and data monitoring gathered in the Cloud through variety of global networks. If determined from the health and diagnostic information and data uploaded to the cloud that a component (e.g., the cryo pump 130) is faulty, the technician at the vendor site 170 can at least one of, schedule a service for the cryo pump 130, order a replacement part for the cryo pump 130 and order a replacement cryo pump 130 to be delivered to a site of the semiconductor manufacturing system 100.

In some embodiments in accordance with the present principles in which an IoT controller of the present principles has two-way communication capability, a technician, using an interface and appropriate software, for example in one embodiment, Microsoft Azure IoT portal, can communicate commands to the IoT controller 140 via the internet 150 to be forwarded to the cryo pump controller 132 and ultimately to the cryo pump 130 to make adjustments to the cryo pump 130 to improve the operating performance of the cryo pump 130, for example, to perform a remote service on the cryo pump 130.

Referring back to FIG. 1, in some embodiments in accordance with the present principles, the IoT controller 140 is configured to receive health and diagnostic information and data of the cryo pump 130 from the cryo pump controller 132 and evaluate the health and diagnostic information and data to determine if the cryo pump 130 is faulty. In such embodiments, the IoT controller 140 can compare the health and diagnostic information and data received from the cryo pump controller 132 to known values to determine if the cryo pump 130 is faulty. For example, in some embodiments in accordance with the present principles, the IoT controller 140 can have stored information regarding thresholds or optimal operating ranges/values for operating parameters of the cryo pump 130 and can compare the health and diagnostic information and data received from the cryo pump controller 132 to determine if the operating ranges/values of the cryo pump 130 are outside of the optimal operating ranges/values to determine if the cryo pump 130 is faulty. Alternatively or in addition, such information regarding thresholds or optimal operating ranges/values for the operating parameters of the cryo pump 130 can be received by the IoT controller 140 from the cryo pump controller 132 or any other component of the semiconductor manufacturing system 100.

In one example, the cryo pump 130 can have an inverter speed of between 30 to 95 Hertz. The cryo pump controller 132 can communicate the inverter speed of the cryo pump 130 to the IoT controller 140 and the IoT controller 140 can be configured to indicate that the cryo pump is faulty at a certain inverter speed; for example at either below or at 35 Hertz or above or at 90 Hertz.

Although in the embodiment described above, the inverter speed of the cryo pump 130 is the parameter used by the IoT controller 140 to determine if the cryo pump 130 is faulty, in other embodiments in accordance with the present principles, any operating parameter of a component of a substrate processing chamber that can be monitored can be used by an IoT controller in accordance with the present principles to determine if a respective component of a substrate processing chamber is faulty to ultimately, at least one of, order service for the component, order a replacement part for the component and order a replacement component.

Upon determining that the cryo pump 130 is faulty, the IoT controller 140 can then determine if service is needed for the cryo pump 130, if a part has to be ordered for the cryo pump 130 or if the cryo pump 130 needs to be replaced. Such determination can be made by the IoT controller 140, in some embodiments, depending on the severity of, type of, or numbers of the fault(s) identified.

For example, in some embodiments in accordance with the present principles, if an operating range/value for an operating parameter of the cryo pump 130 is only slightly outside of the optimal range/value, and/or if a non-critical operating range/value for an operating parameter of the cryo pump 130 is outside of the optimal range/value, and/or if only a few operating ranges/values for an operating parameter of the cryo pump 130 are outside of the optimal range/value, the IoT controller 140 can send a communication over the internet 150 to a vendor site 170 to indicate that service is required for the cryo pump 130. If however, an operating range/value for an operating parameter of the cryo pump 130 is far outside of the optimal range/value, and/or if a critical operating range/value for an operating parameter of the cryo pump 130 is outside of the optimal range/value, and/or if more than a few operating ranges/values for an operating parameter of the cryo pump 130 are outside of the optimal range/value, the IoT controller 140 can send a communication over the internet 150 to a vendor site 170 to indicate that a replacement part is needed for the cryo pump 130 or that the cryo pump 130 needs to be replaced entirely. Such decisions can be made by the IoT controller 140 based on the health and diagnostic information and data received from the cryo pump controller 132 and the known optimal operating ranges/values for an operating parameter of the cryo pump 130. Although specific examples are described above, the specific examples for how to determine whether a component requires servicing, a replacement part(s), or whether a component requires replacement entirely should not be considered limiting. Other combinations and degrees of faults can be used to make such determinations in accordance with the present principles.

The IoT controller 140 can communicate such determinations over the internet 150 to be evaluated by, for example, a technician at a vendor site 170. In some embodiments, the IoT controller 140 can indicate on a user interface to be viewed by the technician, the decision made on whether a faulty component of a semiconductor manufacturing system needs to be serviced, needs a replacement part or needs to be replaced entirely. Alternatively or in addition, health and diagnostic information and data received by the IoT controller 140 can be communicated over the internet 150 to, for example, a cloud computing environment 160 or a vendor site 170 such that an evaluation can be made by, for example, a technician of a vendor of the faulty component, to determine independently if a faulty component of a semiconductor manufacturing system needs to be serviced, needs a replacement part or needs to be replaced entirely.

Alternatively or in addition, in some embodiments in accordance with the present principles, an IoT controller, such as the IoT controller 140 of the semiconductor manufacturing system 100 FIG. 1, can communicate directly with an ordering and/or scheduling service for, at least one of, ordering and scheduling service for a faulty component (e.g., the cryo pump 130) of the semiconductor manufacturing system 100, ordering a replacement part for the faulty component, and ordering a replacement component. In such embodiments, the communication with the ordering and/or scheduling service can be accomplished over the internet 150 and, alternatively or in addition, can be accomplished via the cloud computing environment 160.

In some embodiments in accordance with the present principles, the IoT controller 140 can communicate a command to a manufacturing device (not shown) to produce a replacement part that has been identified as faulty. For example, the IoT controller 140 can communicate a command to a 3D printer to locally or remotely generate a replacement part. For example, and referring back to FIG. 1, in one embodiment, a component controller, for example the cryo pump controller 132, can communicate to the IoT controller 140 a number of hours of operation of the cryo pump 130. The IoT controller 140 can, based on a number of life hours specified for a part of the cryo pump 130, communicate a command to, for example, a 3D printer to generate a replacement part. For example, if it is know that a seal or gasket of a component (e.g., the cryo pump 130) has a lifetime of 100 hours, the IoT controller 140 can be configured to communicate a command to a 3D printer to generate a replacement seal or gasket after a specific number of hours of operation of the component, for example, after 90 hours. In other embodiments, a complete replacement component can be manufactured for a component identified as being faulty upon receiving a command from the IoT in accordance with the present principles.

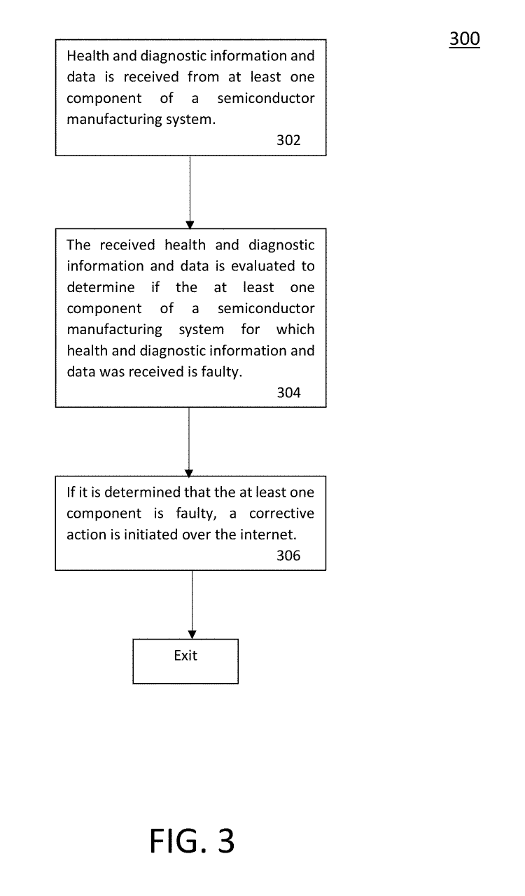

FIG. 3 depicts a flow diagram of a method 300 for internet-based health and diagnostic monitoring of semiconductor manufacturing components to initiate service and parts replacement in accordance with an embodiment of the present principles. The method 300 begins at 302 during which health and diagnostic information and data is received from at least one component of a semiconductor manufacturing system. For example and as described above with respect to FIG. 1, the IoT controller 140 receives health and diagnostic information and data of a cryo pump 130 from a cryo pump controller 132. In some embodiments and as described above, such health and diagnostic information and data can include current operating parameter ranges/values of a component (e.g., the cryo pump 130) of the semiconductor manufacturing system 100 of FIG. 1. The method 300 can proceed to 304.

At 304, the received health and diagnostic information and data is evaluated to determine if the at least one component of a semiconductor manufacturing system for which health and diagnostic information and data was received is faulty. As described above with respect to FIG. 1, in one embodiment, if is determined that at least one of the operating parameter ranges/values of the at least one component (e.g., the cryo pump 130) are outside of a known optimal operating parameter range/value, it can be determined that a fault exists with the at least one component for which the operating parameter range/value is out of range. As described above, in some embodiments the health and diagnostic information and data is communicated over the Internet 150 by, for example the IoT controller, to a remote site, such as a vendor site or a cloud computing environment, for performing such determination and evaluation to be performed. In other embodiments, an IoT controller in accordance with the present principles performs such evaluation and determination. The method 300 can proceed to 306.

At 306, if determined that the at least one component is faulty, a corrective action is initiated over the internet 150. As described above, in some embodiments in accordance with the present principles, at least one of a service is scheduled for the component, a replacement part is ordered for the component, and a replacement component is ordered over the internet 150. As described above, in one embodiment in which the health and diagnostic information and data is communicated by the IoT controller over the internet 150 to a vendor site 170 for evaluation, a technician at the provider site uses the information received over the internet 150 to determine if the at least one component is faulty and determines if at least one of a service should be scheduled for the component, if a replacement part should be ordered for the component, and if a replacement component should be ordered. In some embodiments in which an IoT controller in accordance with the present principles determines if a component is faulty as described above, the IoT controller communicates a command over the internet 150 to at least one of schedule a service for the component, order a replacement part for the component, and order a replacement component. The method 300 can be exited.

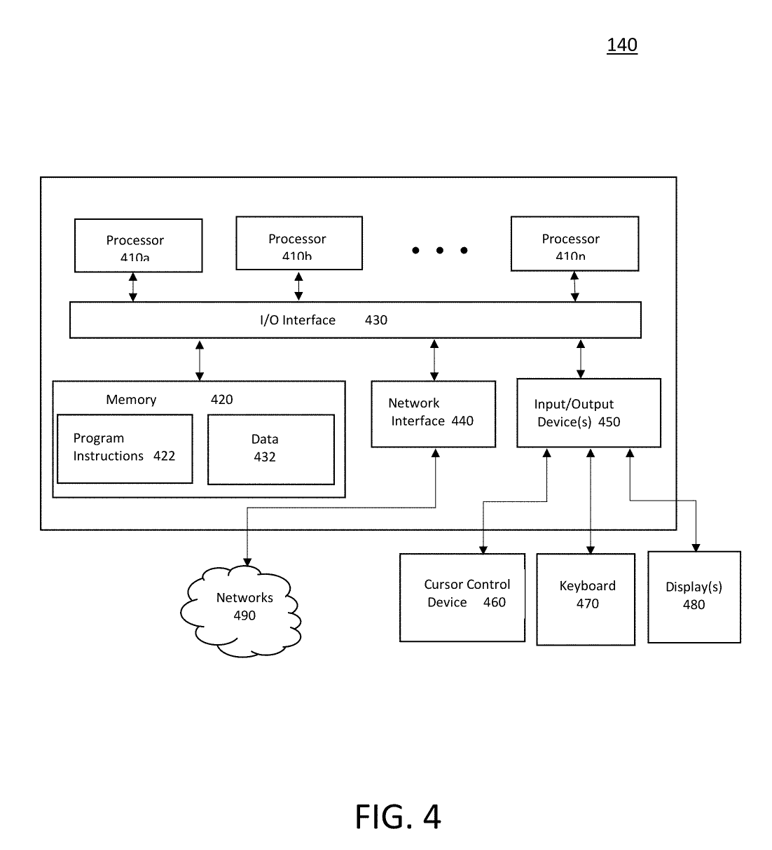

FIG. 4 depicts a high level block diagram of an internet of things (IoT) controller 140 in accordance with an embodiment of the present principles. The IoT controller 140 may be used to implement any other system, device, element, functionality or method of the above-described embodiments. In the illustrated embodiments, IoT controller 140 may be configured to implement method 300 as processor-executable executable program instructions 422 (e.g., program instructions executable by processor(s) 410) in various embodiments.

In the illustrated embodiment, IoT controller 140 includes one or more processors 410a-410n coupled to a system memory 420 via an input/output (I/O) interface 430. IoT controller 140 further includes a network interface 440 coupled to I/O interface 430, and one or more input/output devices 460, such as a cursor control device keyboard 470, and display(s) 480. In some embodiments, the keyboard 470 may be a touchscreen input device.

In different embodiments, the IoT controller 140 may be any of various types of devices, including, but not limited to, personal computer systems, mainframe computer systems, handheld computers, workstations, network computers, application servers, storage devices, a peripheral devices such as a switch, modem, router, or in general any type of computing or electronic device.

In various embodiments, the IoT controller 140 may be a uniprocessor system including one processor 410, or a multiprocessor system including several processors 410 (e.g., two, four, eight, or another suitable number). Processors 410 may be any suitable processor capable of executing instructions. For example, in various embodiments processors 410 may be general-purpose or embedded processors implementing any of a variety of instruction set architectures (ISAs). In multiprocessor systems, each of processors 410 may commonly, but not necessarily, implement the same ISA.

System memory 420 may be configured to store program instructions 422 and/or data 432 accessible by processor 410. In various embodiments, system memory 420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 420. In other embodiments, program instructions and/or data may be received, sent or stored upon different types of computer-accessible media or on similar media separate from system memory 420 or the IoT controller 140.

In one embodiment, I/O interface 430 may be configured to coordinate I/O traffic between processor 410, system memory 420, and any peripheral devices in the device, including network interface 440 or other peripheral interfaces, such as input/output devices 450. In some embodiments, I/O interface 430 may perform any necessary protocol, timing or other data transformations to convert data signals from one component (e.g., system memory 420) into a format suitable for use by another component (e.g., processor 410). In some embodiments, I/O interface 430 may include support for devices attached through various types of peripheral buses, such as a variant of the Peripheral Component Interconnect (PCI) bus standard or the Universal Serial Bus (USB) standard, for example. In some embodiments, the function of I/O interface 430 may be split into two or more separate components, such as a north bridge and a south bridge, for example. Also, in some embodiments some or all of the functionality of I/O interface 430, such as an interface to system memory 420, may be incorporated directly into processor 410.

Network interface 440 may be configured to allow data to be exchanged between the IoT controller 140 and other devices attached to a network (e.g., network 490), such as one or more external systems. In various embodiments, network 490 may include one or more networks including but not limited to Local Area Networks (LANs) (e.g., an Ethernet or corporate network), Wide Area Networks (WANs) (e.g., the Internet), wireless data networks, cellular networks, Wi-Fi, some other electronic data network, or some combination thereof. In various embodiments, network interface 440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 450 may, in some embodiments, include one or more display devices, keyboards, keypads, cameras, touchpads, touchscreens, scanning devices, voice or optical recognition devices, or any other devices suitable for entering or accessing data. Multiple input/output devices 450 may be present in the IoT controller 140. In some embodiments, similar input/output devices may be separate from the IoT controller 140.

In some embodiments, the illustrated computer system may implement any of the methods described above, such as the methods illustrated by the flowchart of FIG. 3. In other embodiments, different elements and data may be included.

The IoT controller 140 of FIG. 4 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. The IoT controller 140 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

While various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from the IoT controller 140 may be transmitted to the IoT controller 140 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of the present disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present disclosure, other and further embodiments of the disclosure may be devised without departing from the basic scope thereof.

1. A method for internet-based health and diagnostic monitoring of semiconductor manufacturing components, comprising:
receiving health and diagnostic information and data from at least one component of a semiconductor manufacturing system;
evaluating the received health and diagnostic information and data to determine if at least one of the at least one component of the semiconductor manufacturing system for which the health and diagnostic information and data was received is faulty; and
if determined that at least one of the at least one component of the semiconductor manufacturing system is faulty, initiating a corrective action for the faulty component over the internet.

2. The method of claim 1, wherein the health and diagnostic information and data includes operating parameter ranges/values for operating parameters of the at least one component.

3. The method of claim 2, wherein the evaluating comprises:
comparing at least one received operating parameter range/value for an operating parameter of the at least one component to an optimal range/value for the operating parameter.

4. The method of claim 3, wherein if the at least one received operating parameter range/value for the operating parameter of the at least one component is not within a threshold of the optimal range/value, the component is considered to be faulty.

5. The method of claim 1, wherein the corrective action includes at least one of communicating with a faulty component to adjust an operating parameter of the faulty component, ordering a service for the faulty component, ordering a replacement part for the faulty component and ordering a replacement component.

6. The method of claim 1, wherein the evaluating is performed by a controller local to the at least one component.

7. The method of claim 1, wherein the evaluating is performed by a technician at a vendor site.

8. The method of claim 1, wherein corrective action includes communicating a command to a manufacturing device to produce a replacement part for the at least one component identified as being faulty.

9. The method of claim 8, wherein the manufacturing device comprises a 3D printer.

10. The method of claim 1, where the corrective action is initiated in a cloud computing environment.

11. An apparatus for internet-based health and diagnostic monitoring of semiconductor manufacturing components, comprising:
a memory to store at least program instructions and data;
a processor, when executing the program instructions, to configure the apparatus to:
receive health and diagnostic information and data from at least one component of a semiconductor manufacturing system;
evaluate the received health and diagnostic information and data to determine if at least one of the at least one component of the semiconductor manufacturing system for which the health and diagnostic information and data was received is faulty; and
if determined that at least one of the at least one component of the semiconductor manufacturing system is faulty, initiate a corrective action for the faulty component over the internet.

12. The apparatus of claim 11, wherein if determined that at least one of the at least one component of the semiconductor manufacturing system is faulty, the apparatus communicates instructions to a cloud computing environment to initiate at least one of communicating with a faulty component to adjust an operating parameter of the faulty component, ordering a service for the faulty component, ordering a replacement part for the faulty component and ordering a replacement component.

13. The apparatus of claim 12, wherein the ordering is fulfilled by a technician in communication with the cloud computing environment.

14. The apparatus of claim 12, wherein the instructions are communicated to an ordering service via the cloud computing environment.

15. The apparatus of claim 11, wherein the apparatus communicates the received health and diagnostic information and data over the internet to a remote vendor site to be evaluated and to determine if that at least one of the at least one component of the semiconductor manufacturing system is faulty.

16. The apparatus of claim 11, wherein the apparatus communicates the received health and diagnostic information and data over the internet to a remote cloud computing environment to be evaluated and to determine if that at least one of the at least one component of the semiconductor manufacturing system is faulty.

17. A semiconductor manufacturing system for internet-based health and diagnostic monitoring of semiconductor manufacturing components, comprising:
a process chamber to process substrates, the process chamber comprising at least one component;
an apparatus comprising a memory to store at least program instructions and data and a processor, when executing the program instructions, to configure the apparatus to:
receive health and diagnostic information and data from the at least one component of the process chamber;
evaluate the received health and diagnostic information and data to determine if at least one of the at least one component of process chamber for which the health and diagnostic information and data was received is faulty; and
if determined that at least one of the at least one component of the process chamber is faulty, initiate a corrective action for the faulty component over the internet.

18. The system of claim 17, wherein if determined that at least one of the at least one component of the process chamber is faulty, the apparatus communicates instructions to a cloud computing environment to initiate at least one of communicating with a faulty component to adjust an operating parameter of the faulty component, ordering a service for the faulty component, ordering a replacement part for the faulty component and ordering a replacement component.

19. The apparatus of claim 17, wherein the apparatus communicates the received health and diagnostic information and data over the internet to a remote cloud computing environment to be evaluated and to determine if that at least one of the at least one component of the semiconductor manufacturing system is faulty.

20. A method for internet-based health and diagnostic monitoring of semiconductor manufacturing components, comprising:
receiving health and diagnostic information and data from at least one component of a semiconductor manufacturing system; and
communicating the received health and diagnostic information and data over the internet to a remote site at which a determination is made if at least one of the at least one component of the semiconductor manufacturing system for which the health and diagnostic information and data was received is faulty and if determined that at least one of the at least one component of the semiconductor manufacturing system is faulty, a corrective action is initiated for the faulty component over the internet.
